(19) United States
(12) Patent Application Publication
(10) Pub. No.: US 2026/0299645 A1
(43) Pub. Date: Oct. 1, 2026

(54) CONTROL METHOD FOR A DETACHABLE SYSTEM AND DETACHABLE SYSTEM

(71) Applicant: COMPAL ELECTRONICS, INC., Taipei City (TW)

(72) Inventors: Chang-Chia Liu, Taipei City (TW); Cheng-Yen Chen, Taipei City (TW); Yi-Chia Lee, Taipei City (TW); Cheng-Min Chen, Taipei City (TW); I-Lung Chen, Taipei City (TW)

(73) Assignee: COMPAL ELECTRONICS, INC., Taipei City (TW)

(21) Appl. No.: 19/574,428

(22) Filed: Mar. 22, 2026

Related U.S. Application Data
(60) Provisional application No. 63/778,398, filed on Mar. 27, 2025.

(51) Int. Cl. G06F 1/16; G06F 3/0484; G06F 3/16

(52) U.S. Cl. CPC G06F 1/1654; G06F 1/1677; G06F 3/0484; G06F 3/167

(57) ABSTRACT

A control method for a detachable system and the detachable system are provided. The detachable system includes a host device and an assistant device, and the host device and the assistant device are detachable or combinable. In the control method, posture information of the assistant device is detected. State information of the host device and the assistant device is detected, where the state information is one of a detach state and a combined state. A target function among multiple interactive functions between the host device and the assistant device is activated according to the state information or the posture information. Accordingly, functional modes could be switched through intuitive operations, thereby enhancing human-computer interaction experience.

### CROSS-REFERENCE TO RELATED APPLICATION

This application claims the priority benefit of U.S. provisional application serial no. 63/778,398, filed on Mar. 27, 205. The entirety of the above-mentioned patent application is hereby incorporated by reference herein and made a part of this specification.

### BACKGROUND

### Technical Field

This disclosure relates to a control technology, and particularly relates to a control method for a detachable system and a detachable system.

### Related Art

With the development of Artificial Intelligence (AI) technology, the interaction methods between electronic devices (for example, laptop computers or All-in-One (AIO) computers) and users are trending toward intuitive operation. In order to provide diverse operation interfaces, computer systems configured with second screens or auxiliary input devices have appeared in the existing technology, and are used to assist in processing multitasking or specific control instructions.

In practical application scenarios, users need to frequently change the operation mode of auxiliary devices according to different task requirements (for example, voice dialogue, digital drawing, or document scanning). However, when switching function modes, existing systems usually require manual settings or window switching, which easily leads to chaotic conditions in the main screen layout when performing complex multitasking processing.

In addition, when auxiliary devices are used separately from the host, privacy protection of images or sensitive data during wireless transmission, and how to effectively allocate computing resources to avoid unnecessary power consumption, are still directions to be improved in related technical fields.

### SUMMARY

The disclosure provides a control method for a detachable system and a detachable system, allowing users to switch functions using intuitive operations and enhancing privacy security.

The control method for a detachable system according to an embodiment of the disclosure, the detachable system includes a host device and an assistant device, and the host device and the assistant device may be detachable or combinable. The control method includes (but is not limited to) the following. Posture information of the assistant device is detected. State information of the host device and the assistant device is detected, wherein the state information is one of a combined state and a detach state. According to the state information or the posture information, a target function among multiple interactive functions between the host device and the assistant device is activated.

The detachable system according to an embodiment of the disclosure includes a host device and an assistant device. The host device and the assistant device may be detachable or combinable. The assistant device detects its posture information, the assistant device detects state information between itself and the host device, and the assistant device activates a target function among multiple interactive functions between the host device and the assistant device according to the state information or the posture information. The state information is one of a combined state and a detach state.

Based on the above, the control method for a detachable system and the detachable system of the disclosure may automatically switch between different interactive modes (for example, voice, touch, or scan modes) by detecting the placement posture of the assistant device. Thereby, users may obtain intuitive operation experience in different task scenarios without manually performing complex settings. In addition, combined with the judgment of state information and position relationship information, system resource allocation may be effectively improved and privacy protection may be enhanced.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram of a detachable system according to an embodiment of the disclosure.

FIG. 2 is a schematic diagram of a detachable system according to an embodiment of the disclosure.

FIGS. 3A-3E are schematic diagrams illustrating the storage and separation process of an assistant device in a detachable system according to an embodiment of the disclosure.

FIG. 4 is a flowchart of a control method for a detachable system according to an embodiment of the disclosure.

FIGS. 5A-5C are schematic diagrams illustrating usage scenarios of an assistant device according to an embodiment of the disclosure.

FIG. 6 is a flowchart of transmission control according to an embodiment of the disclosure.

FIG. 7 is a schematic diagram illustrating device detection and display interface according to an embodiment of the disclosure.

FIGS. 8A and 8C are schematic diagrams illustrating display interfaces of an assistant device in different states according to an embodiment of the disclosure.

FIG. 9A is a flowchart of overall operation according to an embodiment of the disclosure.

FIG. 9B is a flowchart of position detection judgment according to an embodiment of the disclosure.

FIG. 9C is a flowchart of position detection judgment according to another embodiment of the disclosure.

FIG. 10 is a schematic diagram illustrating a display interface in a combined state according to an embodiment of the disclosure.

FIG. 11 is an operational flowchart illustrating scan or photograph mode in a detach state according to an embodiment of the disclosure.

FIG. 12A is a schematic diagram illustrating a detach state according to an embodiment of the disclosure.

FIG. 12B is a schematic diagram illustrating manual switching mode according to an embodiment of the disclosure.

FIG. 13 is an operational flowchart illustrating touch drawing mode according to an embodiment of the disclosure.

FIG. 14 is a schematic diagram illustrating automatic detection mode according to an embodiment of the disclosure.

FIG. 15 is a schematic diagram illustrating manual switching mode according to an embodiment of the disclosure.

FIG. 16A is a schematic diagram illustrating disconnection or no power according to an embodiment of the disclosure.

FIG. 16B is a schematic diagram illustrating an assistant device having no power according to an embodiment of the disclosure.

### DESCRIPTION OF THE EMBODIMENTS

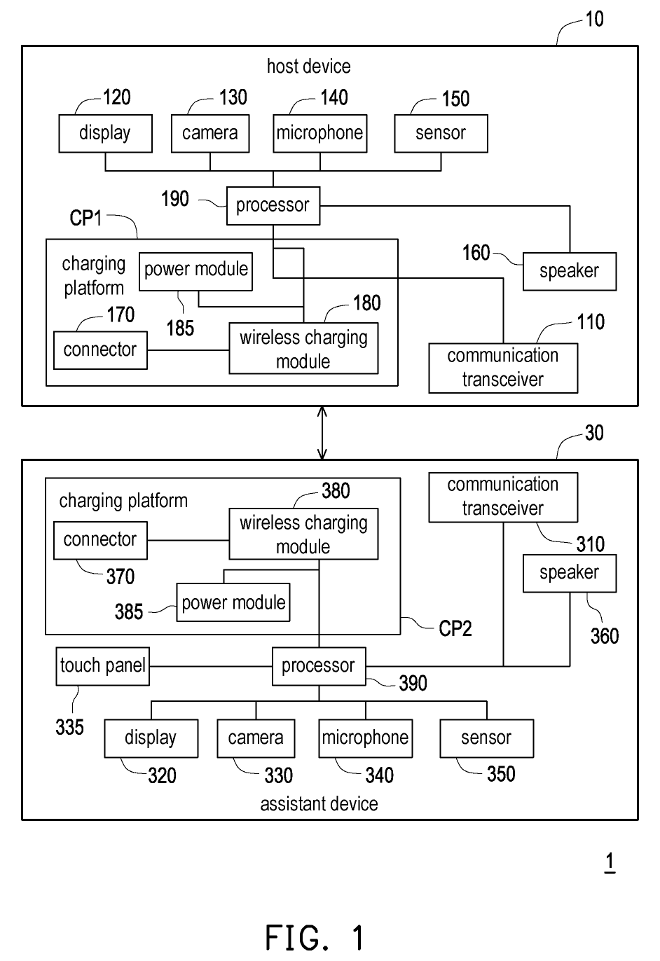

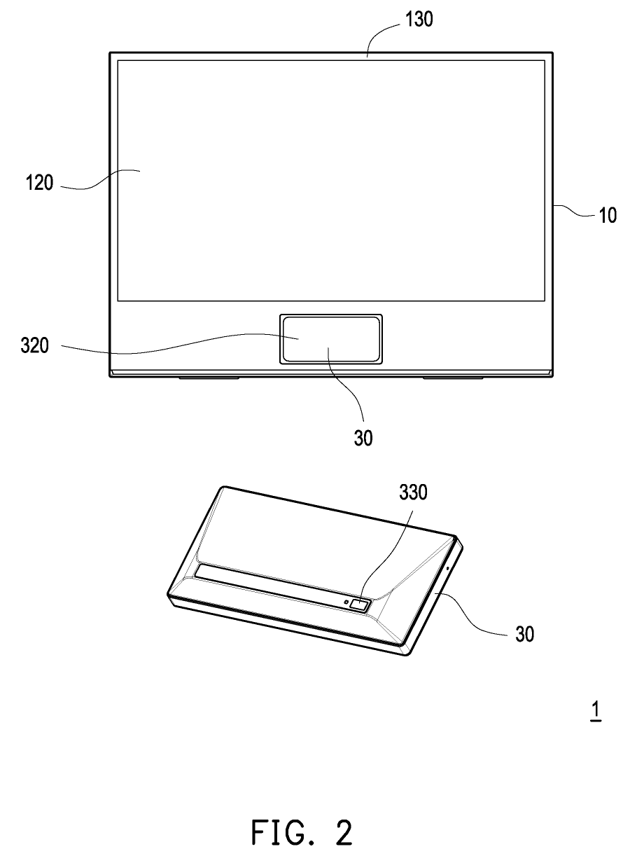

FIG. 1 is a block diagram of a detachable system 1 according to an embodiment of the disclosure, and FIG. 2 is a schematic diagram of the detachable system 1 according to an embodiment of the disclosure. Referring to FIGS. 1 and 2, the detachable system 1 includes a host device 10 and an assistant device 30.

In some application scenarios, the host device 10 may serve as a computing and control center in the detachable system 1. The host device 10 is, for example, an all-in-one computer, a laptop computer, a server, a wearable device, a smart assistant device, a smart home appliance, or other electronic devices. The host device 10 may include (but is not limited to) a wireless communication transceiver 110, a display 120, a camera 130, a microphone 140, a sensor 150, a speaker 160, a connector 170, a wireless charging module 180, a power module 185, a charging platform CP1, and a processor 190.

The wireless communication transceiver 110 may be a transceiver circuit supporting Bluetooth, Wi-Fi, Ultra-wideband (UWB), Near Field Communication (NFC), or other wireless communication protocols. In one embodiment, the wireless communication transceiver 110 establishes a data connection with the assistant device 30, and receives data from the assistant device 30 and/or transmits data to the assistant device 30.

The display 120 may be a liquid crystal display (LCD), a light-emitting diode (LED) screen, or an organic light-emitting diode (OLED) screen. In one embodiment, the display 120 is used to display a main operating system window or display image data from the assistant device 30.

The camera 130 may be a color (RGB) camera or a video camera. In one embodiment, the camera 130 is used to capture environmental images (the field of view of which may be adjusted according to application requirements). These environmental images may be used for performing face recognition, gesture analysis, position detection, or other image processing.

The microphone 140 may be a dynamic, condenser, micro-electro-mechanical system (MEMS), or other type of microphone. In one embodiment, the microphone 140 is used to receive sound waves (for example, human voice, environmental sound, or machine operating sound), and convert them into audio signals accordingly. In some application scenarios, the audio signals include voice commands from the user. In some embodiments, multiple microphones 140 may form a microphone array.

The sensor 150 may be a light sensor, a temperature sensor, a humidity sensor, or a human body sensor (P-sensor). In one embodiment, the sensor 150 is used to sense the light intensity or brightness of the surrounding environment of the host device 10, or sense the presence of a human body.

In one embodiment, the speaker 160 is used to play audio signals.

The connector 170, wireless charging module 180, and charging platform CP1 may serve as physical connection and power output interfaces. The charging platform CP1 may be used for placing other devices or objects. For example, the assistant device 30 may be placed on the charging platform CP1.

The connector 170 is disposed on the charging platform CP1, and may be a Pogo Pin structure, a magnetic attraction structure, a snap-fit structure, or other combining structure. When the assistant device 30 is attached to the charging platform CP1, the connector 170 achieves electrical connection with the assistant device 30, and transmits data/signals accordingly.

The wireless charging module 180 may be a power transmission coil and driving circuit that complies with the Qi standard or Magnetic Resonance standard established by the Wireless Power Consortium (WPC). In one embodiment, the wireless charging module 180 charges the assistant device 30 placed on the charging platform CP1 through electromagnetic induction.

The power module 185 is coupled to the wireless charging module 180 and other components. The power module 185 may be an alternating current to direct current (AC-to-DC) power supply, a Voltage Regulator Module (VRM), a lithium-ion battery pack, or a Power Management IC (PMIC). In one embodiment, the power module 185 is used to receive external power or internal stored electrical energy, and execute voltage conversion and voltage regulation processing to output operating voltages required for the operation of the communication transceiver 110, display 120, or other components.

The processor 190 is in communication with the wireless communication transceiver 110, display 120, camera 130, microphone 140, sensor 150, speaker 160, connector 170, wireless charging module 180, and power module 185. The processor 190 may be a Central Processing Unit (CPU), or other programmable general-purpose or special-purpose microprocessor, Digital Signal Processor (DSP), programmable controller, Application-Specific Integrated Circuit (ASIC), neural network accelerator, or other similar components or a combination of the above components. In some embodiments, some functions of the processor 190 may be implemented through software.

In some application scenarios, the host device 10 serves as the primary computing device, while the assistant device 30 transmits data/information/signals for further processing by the host device 10.

On the other hand, the assistant device 30 is, for example, a detachable smart display, tablet computer, or dedicated AI agent device. When the assistant device 30 is combined with the host device 10, it may be regarded as a second screen or auxiliary interface of the host device 10; and when the assistant device 30 is separated from the host device 10, it may serve as an independent input or display device, and interact with the host device 10 through wireless means.

The assistant device 30 may include (but is not limited to) a wireless communication transceiver 310, a display 320, a camera 330, a microphone 340, a sensor 350, a speaker 360, a connector 370, a wireless charging module 380, a power module 185, a charging platform CP2, and a processor 390.

The implementation aspects and functions of the wireless communication transceiver 310, display 320, camera 330, touch panel 335, microphone 340, sensor 350, speaker 360, connector 370, wireless charging module 380, power module 185, charging platform CP2, and processor 390 may respectively refer to the descriptions of the wireless communication transceiver 110, display 120, camera 130, microphone 140, sensor 150, speaker 160, connector 170, wireless charging module 180, power module 185, charging platform CP1, and processor 190, and will not be elaborated in the following.

The implementation aspects and functions of the wireless communication transceiver 310 correspond to the wireless communication transceiver 110 of the host device 10. In one embodiment, the wireless communication transceiver 310 may transmit user operation data received by the assistant device 30 (for example, voice, image, touch trajectory related data) to the host device 10, or receive display screen information from the host device 10.

In one embodiment, the display 320 is used to display information or screens.

In one embodiment, the input device of the assistant device 30 includes at least one of the camera 330, touch panel 335, or microphone 340. The input device is used to receive user operation data.

In one embodiment, the camera 330 may be disposed on the back or front of the assistant device 30 as shown in FIG. 2 (but is not limited to this position), and is used for photographing external objects or scanning documents. At this time, the user operation data includes image data captured by the camera 330.

In one embodiment, the touch panel 335 may be configured on the display side of the display 320 as shown in FIG. 2, and is used to provide touch input function. The touch panel 335 may be a capacitive, resistive, surface acoustic wave, or infrared touch panel. In one embodiment, the touch panel 335 receives user touch operations (for example, clicking, sliding, handwriting, or drawing operations), and transmits corresponding touch signals to the processor 390 to generate touch trajectory data. At this time, the user operation data includes touch trajectory data.

In one embodiment, the microphone 340 is used to receive user voice data. At this time, the user operation data includes voice data.

The sensor 350 may be an Inertial Measurement Unit (IMU), for example, a gravity sensor (G-sensor), an accelerometer, or a gyroscope. In one embodiment, the sensor 350 is used to detect posture information of the assistant device 30. The posture information includes tilt angle, spatial orientation, movement speed, or acceleration change of the assistant device 30.

In one embodiment, the speaker 360 is used to play feedback sound effects or responses from the voice assistant.

The connector 370, wireless charging module 380, and charging platform CP2 (or referred to as connection interface) are interfaces used to combine with the host device 10. In one embodiment, when the charging platform CP2 of the assistant device 30 combines with the charging platform CP1 of the host device 10, the connector 370 contacts the connector 170 to transmit signals, and the wireless charging module 380 receives power from the wireless charging module 180 to charge the power module 385 (for example, battery).

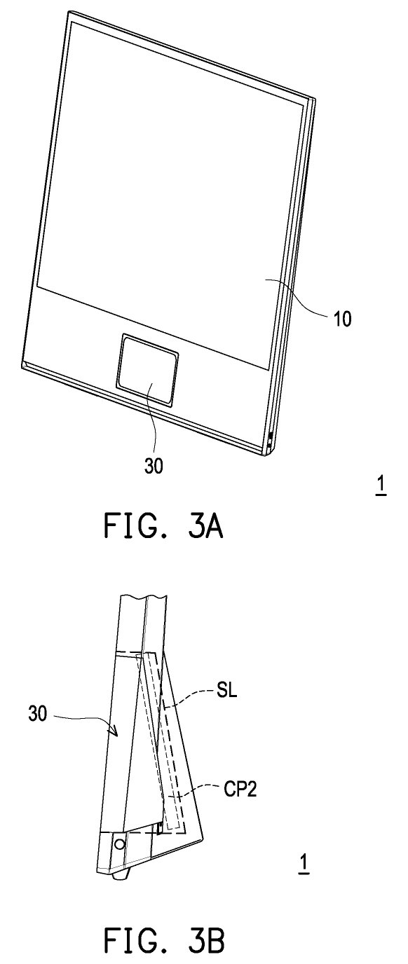

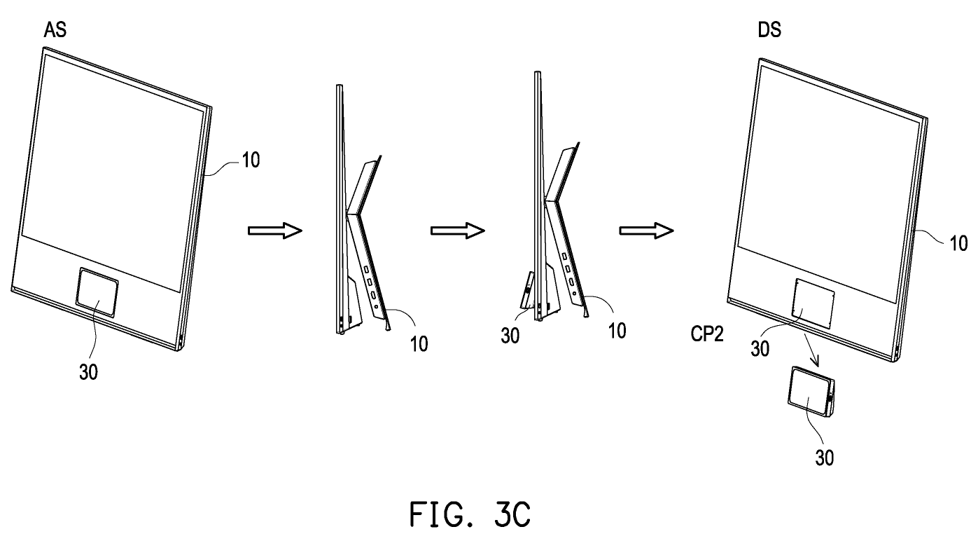

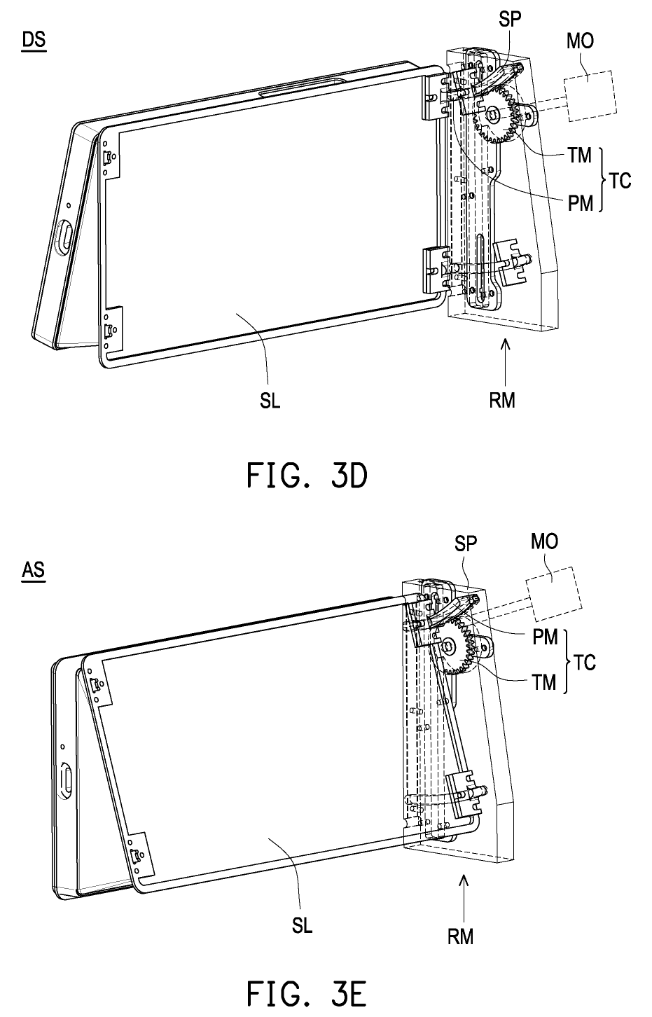

For clearly illustrating the mechanical interaction relationship between the host device 10 and the assistant device 30, referring to FIGS. 3A-3E. FIGS. 3A-3E are schematic diagrams illustrating the storage and separation process of an assistant device in a detachable system according to one embodiment of the disclosure. Here, the “state information” between the host device 10 and the assistant device 30 is first defined. The state information includes “combined state” and “detach state”.

As shown in FIG. 3A, when the assistant device 30 is attached to the connection platform of the host device 10 (such as the charging platform CP1), the host device 10 and the assistant device 30 are in a combined state. In one embodiment, as shown in FIGS. 3D and 3E, the charging platform CP1 further includes a flip mechanism RM, disposed inside the host device 10 (as shown integrated in a connection platform SL in FIG. 3B), and the flip mechanism RM includes a motor MO, a track platform SP, and a transmission module TC, wherein the transmission module TC is configured on the track platform SP and includes a transmission component TM (such as a rack) and a passive component PM (rack), and the passive component PM is connected between the transmission component TM and the connection platform SL. As shown in FIG. 3C under a combined state AS, the assistant device 30 is adapted to attach to the connection platform SL shown in FIG. 3B. The power of the motor MO sequentially passes through the transmission component TM and the passive component PM, causing the passive component PM to drive the connection platform SL to move along the path on the track platform SP, thereby driving the assistant device 30 to sink into the housing of the host device 10, so that the front surface of the assistant device 30 (such as the side where the display 320 is disposed) is flush with the front surface of the host device 10 (such as the side where the display 120 is disposed), presenting an integrated appearance. At this time, the assistant device 30 may be regarded as a second screen of the host device 10 or in a sleep charging mode.

It is worth noting that the processor 190 also communicates with the motor MO, the processor 190 judges the state information between the host device 10 and the assistant device 30, and subsequently triggers the motor MO to operate to execute the rotation of the connection platform SL. As shown in FIGS. 3B and 3C, when the assistant device 30 needs to be separated for use, the host device 10 drives the connection platform SL to rotate in reverse and push upward to switch to an external position, enabling the assistant device 30 to separate from the connection platform SL. In operation, when the assistant device 30 is pressed by external force (for example, the assistant device 30 may be pressed), the assistant device 30 will be pushed up by the connection platform SL and pop out. At this time, the host device 10 exposes the connection platform SL, and the assistant device 30 is pushed up to a position convenient for access. After the assistant device 30 is removed from the connection platform SL, the host device 10 and the assistant device 30 are in a detach state DS (as shown in FIG. 3C). On the other hand, as shown in FIG. 3D, the wireless charging module 180 may be configured behind the connection platform SL, so the wireless charging module 180 will also move with the connection platform SL. Under the detach state DS, the assistant device 30 may rely on the power module 385 for power supply and maintain connection with the host device 10 through the wireless communication transceiver 310.

It should be noted that the combined and detach state of the host device 10 and the assistant device 30 are not limited to those shown in FIGS. 3A-3C, and users may adjust the combination mechanism (for example, the connection platform SL) as shown in FIG. 3D and 3E according to actual requirements.

In the following, the method described in the embodiments of the disclosure will be explained in combination with the components, modules and state in FIGS. 1-3C. The process of this method may be adjusted according to implementation situations, and is not limited thereto.

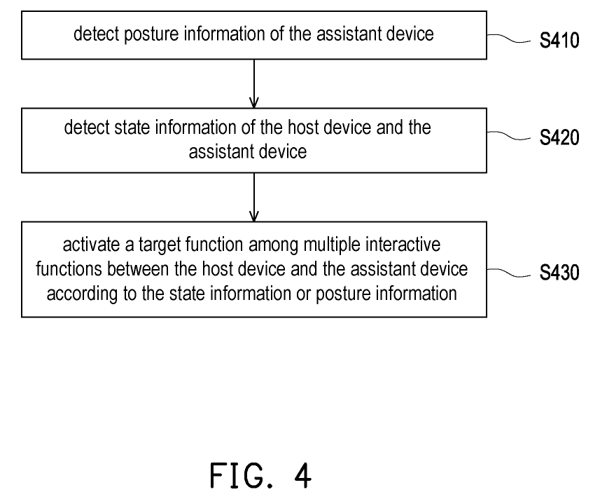

FIG. 4 is a flowchart of a control method for a detachable system according to an embodiment of the disclosure. Referring to FIG. 4, in step S410, posture information of the assistant device is detected. Specifically, the processor 390 of the assistant device 30 detects its physical state in space through the sensor 350 (for example, gravity sensor, gyroscope and/or accelerometer), and generates posture information accordingly. The posture information corresponds to the physical state of the assistant device 30 in space, such as tilt angle, orientation direction, or whether displacement or rotation occurs.

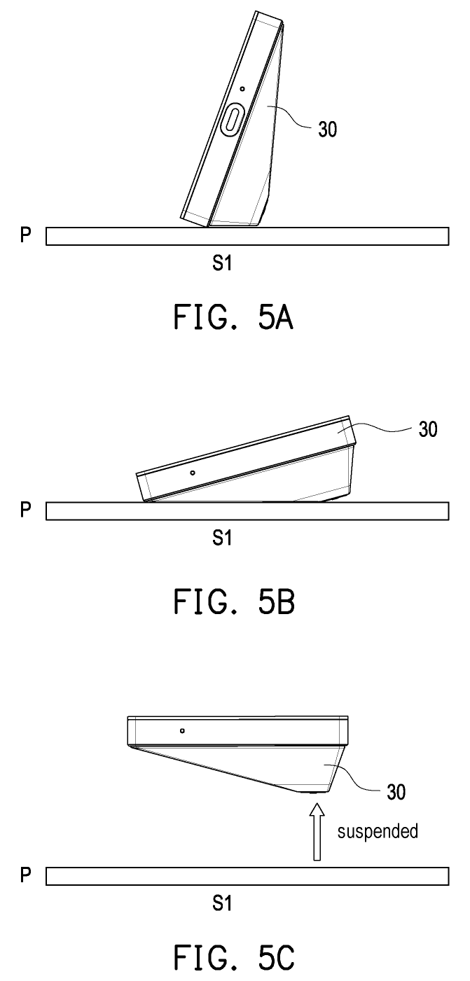

FIGS. 5A-5C are schematic diagrams illustrating usage scenarios of the assistant device 30 according to an embodiment of the disclosure. Referring to FIG. 5A, when the assistant device 30 is placed on a plane P (for example, a desktop), and the sensor 350 detects that the angle between the assistant device 30 and the plane P is greater than a first angle threshold (for example, 60 degrees to 90 degrees) and is in a stationary state, the processor 390 determines that the posture information corresponds to a first state S1 (for example, “standing state”). At this time, the assistant device 30 is like an upright photo frame or smart speaker.

Referring to FIG. 5B, when the assistant device 30 is placed on the plane P, but the sensor 350 detects that the angle between the assistant device 30 and the plane P is less than a second angle threshold (for example, 0 degrees to 30 degrees) and is in a stationary state, the processor 390 determines that the posture information corresponds to a second state S2 (for example, “lying flat state”). At this time, the assistant device 30 is like a drawing tablet or document paper.

Referring to FIG. 5C, when the sensor 350 detects that the assistant device 30 is not in a stationary state (for example, detecting acceleration changes, displacement or vibration), it represents that the user is holding or moving the assistant device 30. Alternatively, the sensor 350 detects that the assistant device 30 is away from the plane P. At this time, regardless of the tilt angle, the processor 390 determines that the posture information corresponds to a third state S3 (for example, “suspended state”) (also referred to as handheld state).

Referring to FIG. 4, in step S420, state information of the host device 10 and the assistant device 30 is detected. Specifically, the processor 390 (or processor 190) continuously monitors whether the assistant device 30 is attached to the host device 10. For example, detecting whether the connector 370 and the connector 170 are in contact (contact indicates a combined state, no contact indicates a detach state), detecting whether the wireless charging module 380 is supplying power (power supply indicates a combined state, no power supply indicates a detach state), or other contact or non-contact detection.

Referring to FIG. 4, in step S430, a target function among multiple interactive functions between the host device 10 and the assistant device 30 is activated according to the state information or posture information. Specifically, multiple interactive modes (i.e., interactive functions) are predefined between the host device 10 and the assistant device 30. The processor 390 of the assistant device 30 (or the processor 190 of the host device 10) infers the user’s current operational intention according to the determined state information (such as the combined state AS or detach state DS as shown in FIG. 3C) or posture information (for example, corresponding to the standing, lying flat, or suspended state as shown in FIGS. 5A-5C), and switches to the corresponding target function. For example, activating a voice input function corresponding to the standing state, activating a touch input function corresponding to the lying flat state, or activating a camera/scan function corresponding to the suspended state. Thereby, the user does not need to go through cumbersome menu settings, but only needs to intuitively change the placement method of the assistant device 30 to seamlessly switch usage scenarios.

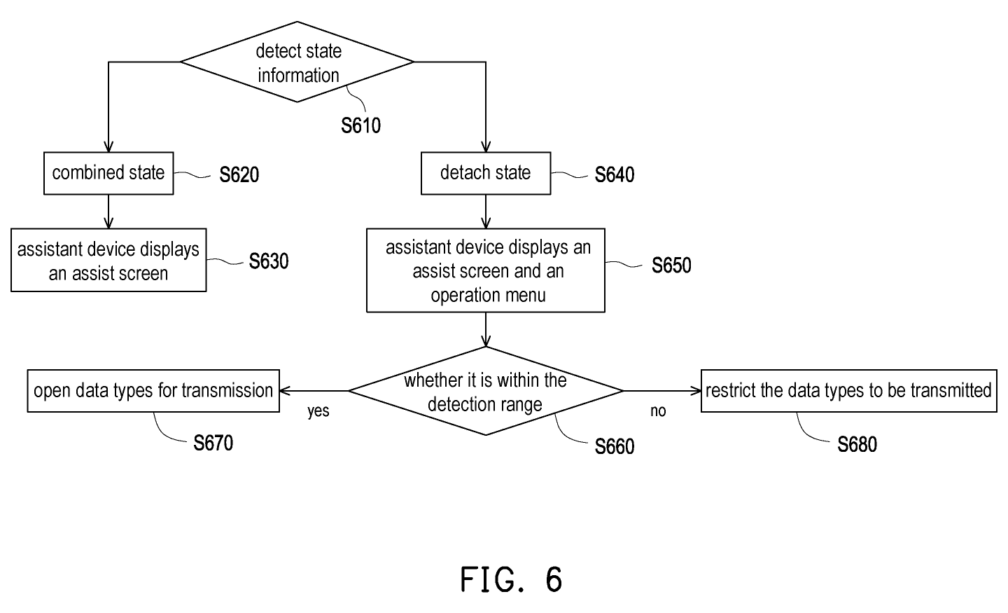

Except for switching functions according to posture information, the embodiments of the disclosure further consider data transmission security and efficiency of the assistant device 30 in two states. Referring to FIG. 6, FIG. 6 is a flowchart of transmission control according to an embodiment of the disclosure. The process of this embodiment may be used to manage the data transmission mechanism between the host device 10 and the assistant device 30.

In step S610, state information of the assistant device 30 is detected. The processor 390 (or processor 190) continuously monitors whether the assistant device 30 is attached to the host device 10.

In step S620, a combined state is detected (combined state AS as shown in FIG. 3C). In step S630, the processor 390 of the assistant device 30 displays an assist screen through the display 320. In this state, the assistant device 30 serves as a second display, displaying extended desktop information, time and date, or standby screen of the host device 10.

In step S640, a detach state is detected (detach state DS as shown in FIG. 3C). In step S650, the processor 390 of the assistant device 30 displays an assist screen and an operation menu through the display 320. The operation menu may include icons for users to manually switch modes (to be detailed later), to provide operational flexibility in addition to automatic detection.

In step S660, it is determined whether the assistant device 30 is within the detection range. Specifically, the processor 190 of the host device 10 or the processor 390 of the assistant device 30 may obtain information such as physical distance, relative orientation, or image features through built-in communication components (for example, UWB, Bluetooth transceiver circuits) or sensing components (for example, cameras, distance sensors) to generate position relationship information. The position relationship information is a parameter used to reflect the relative spatial state or connection authority between the host device 10 and the assistant device 30. The position relationship information includes, for example (but is not limited to), at least one of the following: physical distance information, relative orientation information, visible range information, or user authority verification information. Subsequently, the processor 390 may determine whether the assistant device 30 is within the detection range according to the position relationship information. The detection range is a predefined spatial or authority range, for example, “within 1.5 meters in front of the host and used by the person himself/herself.” The processor 190 (or processor 390) compares the position relationship information with preset conditions.

When the assistant device 30 is within the detection range, in step S670, the processor 390 may open data types for transmission. In this case, the processor 390 determines that the user is in front of the host device 10 or within a trusted range (for example, around a study room or office desk). For example, if the user is using the camera 330 of the assistant device 30 for video conferencing and is determined to be within the detection range (i.e., the position relationship information shows close distance and is an authorized user), the assistant device 30 will directly transmit the captured real-time high-resolution image data (raw data or high-traffic streaming) to the host device 10, and display it in real-time through the display 120 of the host device 10. Alternatively, if the user is performing document scanning, the scanned image files will be synchronized and displayed in real-time on the screen of the host device 10 for the user to preview immediately.

When the assistant device 30 is not within the detection range, in step S680, the processor 390 may restrict the data types transmitted to the host device 10. In this case, the processor 390 determines that the user may have left the seat, is in an environment with higher privacy risk, or the holder is not an authorized user. For example, to protect privacy, the assistant device 30 will automatically switch to “privacy mode,” stopping the transmission of real-time image screens from the camera 330 to the host device 10, preventing bystanders from peeking into the user’s surrounding environment through the large screen of the host device 10. At this time, the data types transmitted to the host device 10 are limited to low-bandwidth “control commands” (for example: previous/next page of presentation, volume adjustment, or media playback pause signals). Alternatively, for the scan function, when outside the detection range, the scanned high-resolution images will be first “temporarily stored” in the memory of the assistant device 30, and automatic synchronization transmission will be triggered only when the position relationship information is updated to “within the detection range.”

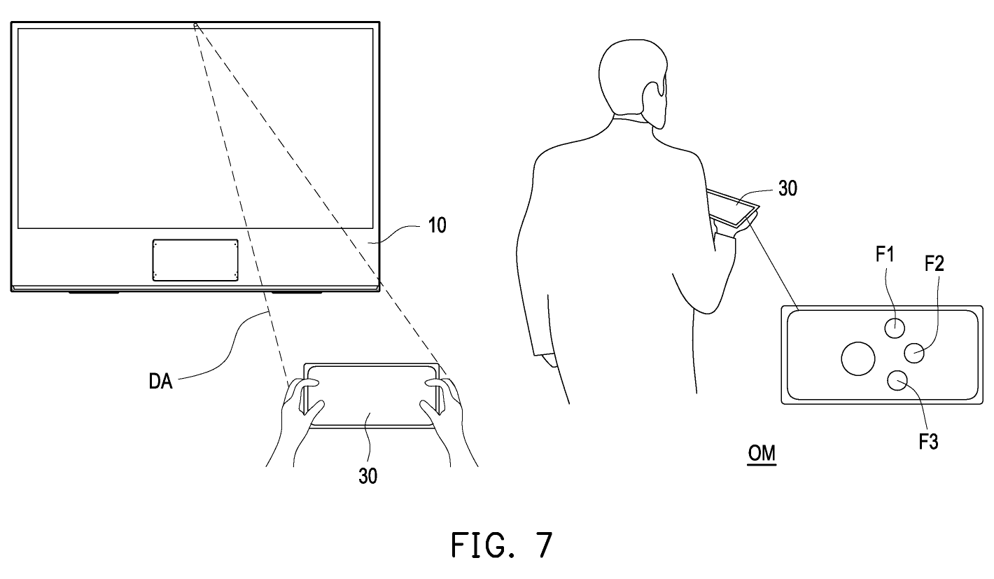

To further illustrate the detection mechanism in the step S660, FIG. 7 is a schematic diagram illustrating device detection and display interface according to an embodiment of the disclosure. Referring to FIG. 7, in one embodiment, the host device 10 uses the camera 130 as a detection component. The camera 130 has a detection range DA (for example, field of view range). The processor 190 analyzes the images captured by the camera 130. When the assistant device 30 is within the detection range DA and the processor 190 recognizes that the holder is an authorized user, it may be determined that the assistant device 30 is within the detection range DA. At this time, the display 120 of the host device 10 may display a prompt message or synchronized screen, indicating that the connection has been established and data transmission is unrestricted. Conversely, if the holder leaves the detection range DA or is recognized as an unauthorized user, it is determined that the assistant device 30 is not within the detection range DA.

In another embodiment, the host device 10 and the assistant device 30 use wireless communication transceivers (for example, UWB modules) for distance measurement. The processor 190 calculates the distance between the two devices. When the distance is less than a preset distance threshold (for example, 1.5 meters), it is determined that the assistant device 30 is within the detection range DA.

Referring to FIG. 7, the scenario shown in the right figure assumes that the assistant device 30 is within the detection range DA. At this time, the assistant device 30 displays an operation menu OM. The operation menu OM includes, for example, a function option F1 corresponding to scan/photograph function, a function option F2 corresponding to touch input function, and a function option F3 corresponding to voice input function.

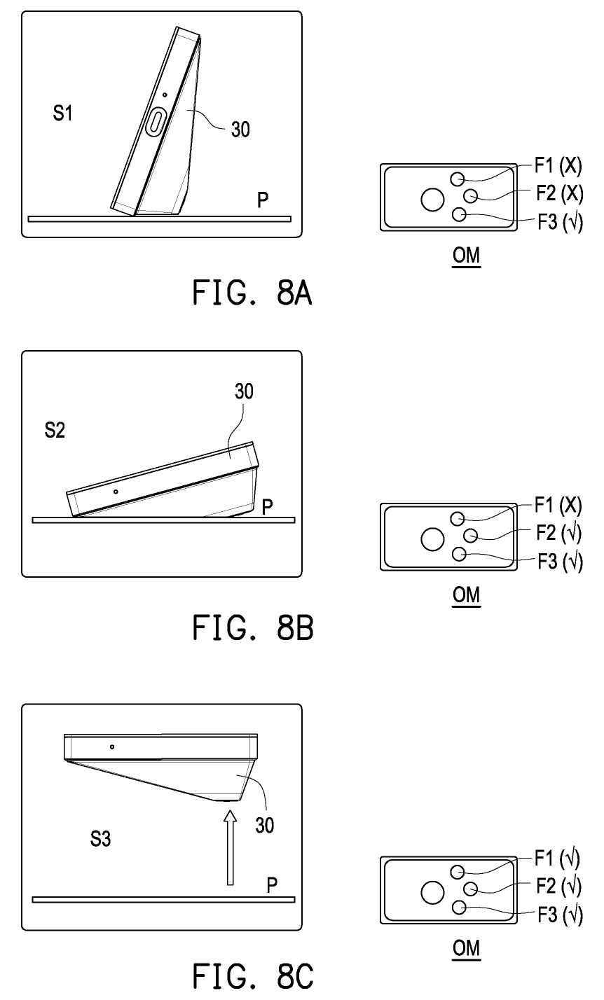

The following continues to illustrate the different operation interfaces presented by the assistant device 30 in the detach state according to posture information. FIGS. 8A-8C are schematic diagrams illustrating display interfaces of the assistant device 30 in different states according to an embodiment of the disclosure. These figures specifically show the implementation aspects of “activating target function” in step S420 of the FIG. 4.

Referring to FIG. 8A, when the posture information detected by the sensor 350 corresponds to the first state S1 (for example, a standing state with an angle greater than 60 degrees with respect to the plane P), the assistant device 30 activates the voice input function. That is, the processor 390 may determine that the target function corresponds to the voice input function at this time. The processor 390 may activate the microphone 340 and accordingly receive voice data. The voice data may be user commands or other recording data. In addition, the display 320 may present a first user interface. The first user interface includes, for example, an avatar emoji or dynamic sound wave icon to prompt the user that voice interaction is available. In this mode, the user operation data is mainly voice data, and the assistant device 30 may serve as a smart speaker or video conference terminal for the host device 10.

Referring to FIG. 8B, when the posture information detected by the sensor 350 corresponds to the second state S2 (for example, a lying flat state with an angle less than 30 degrees with respect to the plane P), the assistant device 30 activates the touch input function or the voice input function. That is, the processor 390 may determine that the target function corresponds to at least one of the touch input function or the voice input function at this time. In addition, the display 320 may present the first user interface, a second user interface, or a combination thereof. The second user interface includes, for example, a drawing canvas, color palette toolbar, or virtual keyboard. In this mode, the user operation data may be touch trajectory data, and the assistant device 30 may serve as a digital drawing tablet or handwriting input tablet for the host device 10. Alternatively, or simultaneously, the user operation data may be voice data.

Referring to FIG. 8C, when the posture information detected by the sensor 350 corresponds to the third state S3 (for example, a handheld moving suspended state), the assistant device 30 activates the photograph or scan function, touch input function, or voice input function. That is, the processor 390 may determine that the target function corresponds to at least one of the voice input function, touch input function, or photograph function at this time. At this time, the display 320 presents the first user interface, the second user interface, a third user interface, or a combination thereof. The third user interface includes, for example, a viewfinder and shutter button. In this mode, the user operation data may be image data. The user may handheld the assistant device 30 to photograph documents or objects, and determine whether to immediately transmit back to the host device 10 according to the data transmission mechanism. Alternatively, or simultaneously, the user operation data may be voice data or touch trajectory data.

On the other hand, as shown in FIGS. 8A-8C, an operation menu OM may also be permanently displayed on the display 320. The operation menu OM includes function options F1, F2, F3 corresponding to scan/photograph function, touch input function, and voice input function respectively. When the assistant device 30 detects posture information and switches modes accordingly, the corresponding function option (for example, the function option F1 in FIG. 8A) will be highlighted or marked (such as checked) to provide intuitive visual feedback. Function options corresponding to non-target functions may be hidden or marked (such as crossed out). In addition, the touch panel 335 may also detect click operations on any one of the function options F1, F2, F3 in the operation menu OM. The processor 390 may manually switch the function options F1, F2, F3 selected by the click operation and switch to the corresponding mode.

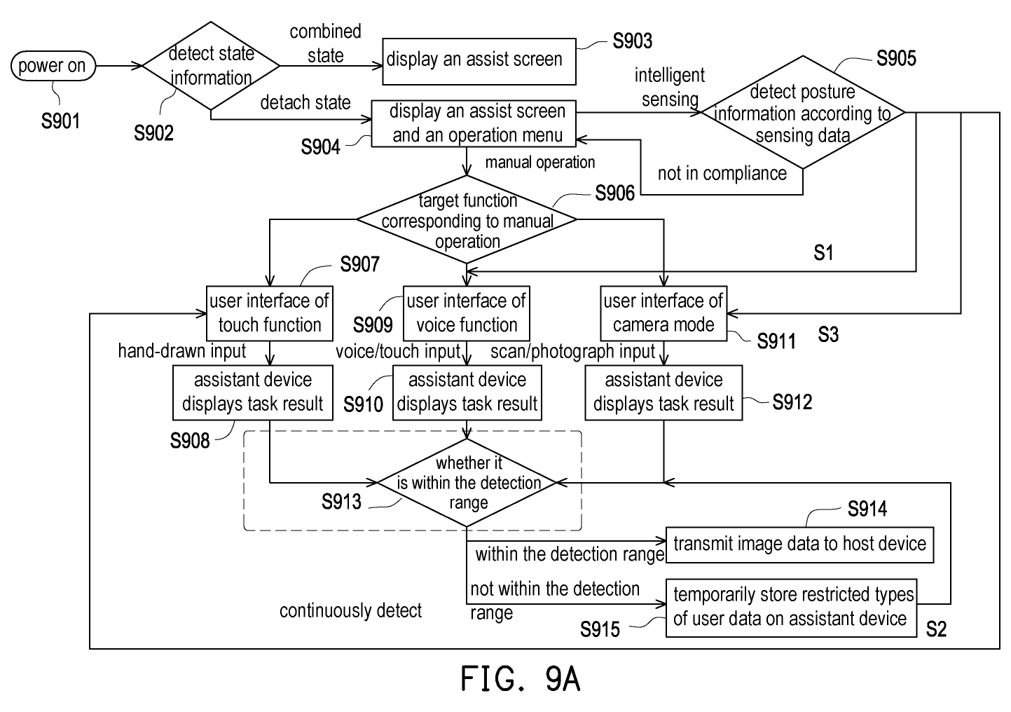

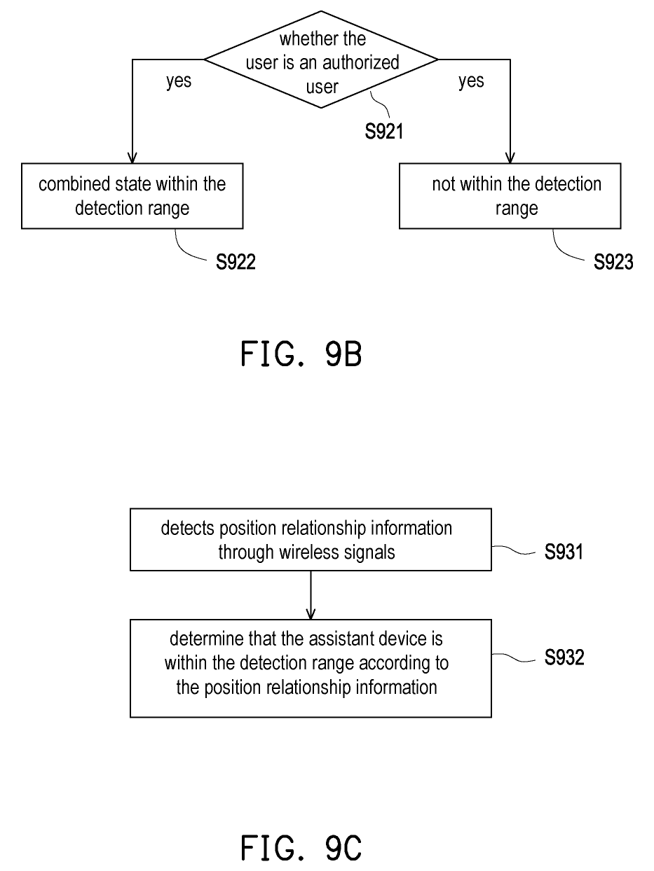

In order to systematically illustrate the operation logic of the embodiments of the disclosure, FIG. 9A is a flowchart of overall operation according to an embodiment of the disclosure. Referring to FIG. 9A, the process begins at step S901 (power on). Next, in step S902, state information between the host device 10 and the assistant device 30 is detected. The state information is one of a combined state and a detach state, e.g., the combined state AS and detach state DS as shown in FIG. 3C.

If determined to be in the combined state, in step S903, combined mode operation is executed. At this time, the assistant device 30 is attached to the host device 10 (for example, through the charging platform CP1 or the connection platform SL), and the processor 390 may disable the target function. That is, disable the target function corresponding to the posture information. For example, disable the voice input function, touch input function, or photograph function. In addition, the processor 390 may disable posture detection or partial sensing functions to save power, and display the assist screen through the display 320.

On the other hand, if determined to be in the detach state, in step S903, intelligent sensing detection mode is activated. The processor 390 activates the sensor 350 (such as gravity sensor, gyroscope) to continuously monitor the posture information of the assistant device 30, and activates the communication component to monitor position relationship information. In addition, the processor 390 may display the assist screen and operation menu (such as the operation menu OM shown in FIG. 7) through the display 320.

For the intelligent sensing detection mode, in step S905, posture information is detected according to sensing data from the sensor 350 (for example, orientation, acceleration, or angular velocity).

On the other hand, the touch panel 335 also detects the function menu selected for manual operation on the operation menu, and switches to the target function corresponding to this function menu accordingly.

Assuming that the function menu corresponding to the touch input function is selected or the second state S2 (i.e., lying flat state) is detected, in step S907, the processor 390 activates the touch input mode/function (i.e., as the target function), and displays the corresponding user interface through the display 320, e.g., the second user interface. In step S908, the display 320 further displays the task result.

Assuming that the function menu corresponding to the voice input function is selected or the first state S1 (i.e., standing state) is detected, in step S909, the processor 390 activates the voice input mode/function (i.e., as the target function), and displays the corresponding user interface through the display 320, i.e., the first user interface. In step S910, the display 320 further displays the task result.

Assuming that the function menu corresponding to the photograph/scan function is selected or the third state S3 (i.e., suspended state) is detected, in step S911, the processor 390 activates the voice input mode/function (i.e., as the target function), and displays the corresponding user interface through the display 320, i.e., the third user interface. In step S912, the display 320 further displays the task result.

In some embodiments, the processor 390 may disable other interactive functions except the target function. For example, when the voice input function is selected as the target function, the touch input function may be disabled.

After confirming the function mode (or simultaneously), in step S913, it is determined whether the device is within the detection range. This step corresponds to the step S660 of FIG. 6. If within the detection range, in step S914, real-time data transmission for user operation data is performed (for example, full resolution image streaming); if not within the detection range, in step S915, limited data transmission is performed (for example, only transmitting control signals, and/or temporarily storing user operation data without transmission).

For the specific algorithm of “determining whether within the detection range” in step S913, it may be further subdivided into two implementations: image judgment and signal judgment. FIG. 9B is a flowchart of position detection judgment according to an embodiment of the disclosure. This process adopts image recognition technology. Here, “authorized user” and “judgment criteria for detection range” need to be defined first. An authorized user refers to a user whose biometric features (such as face, iris) have been pre-registered in the database of the host device 10 or the assistant device 30. In this embodiment, the judgment criteria for “within the detection range” does not depend solely on physical distance, but depends on “whether an authorized user exists in the captured image”. In other words, as long as an authorized user is identified in the captured image, it is considered to satisfy the detection range condition; conversely, if the captured image contains strangers or no one, it is considered not to satisfy the condition.

Referring to FIG. 9B, in step S921, the processor 190 identifies whether the user corresponding to the assistant device 30 is an authorized user in the captured image. Specifically, the camera 130 of the host device 10 captures an environmental image covering its front field of view (i.e., captured image). The processor 190 performs face detection on the captured image and determines whether facial features exist in the captured image. If not, it directly determines that the device is not within the detection range (step S923). If facial features are detected, the processor 190 compares the detected facial features with authorized user data in the database to identify whether the user corresponding to the assistant device 30 is an authorized user.

In step S922, when the user corresponding to the assistant device 30 is identified as an authorized user, the processor 190 determines that the assistant device 30 is within the detection range. At this time, the processor 390 allows high privacy-sensitive data (such as real-time video) to be transmitted.

In step S923, when the user corresponding to the assistant device 30 is not an authorized user (for example, identification failure or a stranger), the processor 190 determines that the assistant device 30 is not within the detection range. At this time, the processor 390 restricts data transmission to protect privacy.

FIG. 9C is a flowchart of position detection judgment according to another embodiment of the disclosure. In this embodiment, the judgment criteria for “within the detection range” is defined as “the physical distance calculated from wireless signals is less than a distance threshold value”.

Referring to FIG. 9C, in step S931, the processor 190 of the host device 10 (or the processor 390 of the assistant device 30) receives wireless signals through the wireless communication transceiver 110 (or the wireless communication transceiver 310), and detects position relationship information accordingly. Specifically, the wireless communication transceiver 110 or the wireless communication transceiver 310 (for example, UWB or Bluetooth transceiver circuit) receives wireless signals from the counterpart. The processor 190 calculates the time of flight (ToF) or signal strength (RSSI) of the wireless signals to obtain distance values (as position relationship information).

In step S932, the processor 190 may determine that the assistant device 30 is within the detection range according to the position relationship information. Specifically, the processor 390 determines whether the distance value converted from the wireless signals is less than a distance threshold value (for example, 1.5 or 2 meters). If yes, it determines that the assistant device 30 is within the detection range according to the position relationship information; if no, it determines that the assistant device 30 is not within the detection range.

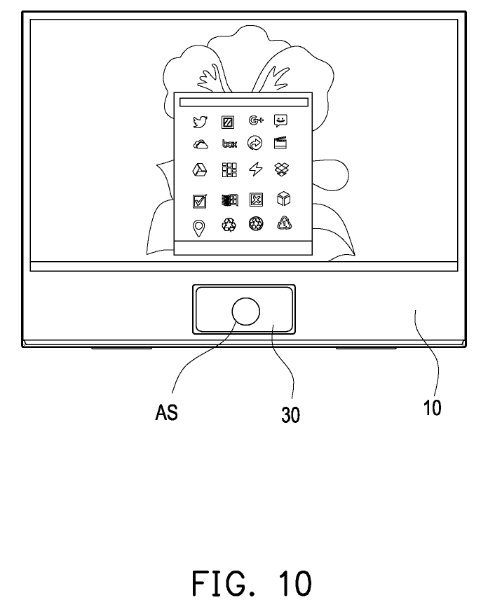

The aforementioned process covers the operation in the detach state, and the following supplements the interface presentation in the combined state. FIG. 10 is a schematic diagram illustrating a display interface in the combined state according to an embodiment of the disclosure. Referring to FIG. 10, when the assistant device 30 is combined with the host device 10 (corresponding to step S902 in FIG. 9), the display 320 of the assistant device 30 and the display 120 of the host device 10 visually form an integration. In this combined state AS, the assistant device 30 displays an assistant screen. The assistant screen may be an Avatar emoji or dynamic sound wave icon. Alternatively, the assistant screen may serve as an Extended Desktop of the host device 10, used to display calendar, weather information, music playback controller, or to-do items. Alternatively, the assistant screen may display charging state information, prompting the user of the current battery percentage of the assistant device 30. In this mode, to avoid operation conflicts, the processor 390 may disable the interactive functions corresponding to the camera 330, the microphone 340, and the touch panel 335 on the back of the assistant device 30, transferring the main control to the input devices of the host device 10 (for example, the microphone 140, mouse, or keyboard) for operation.

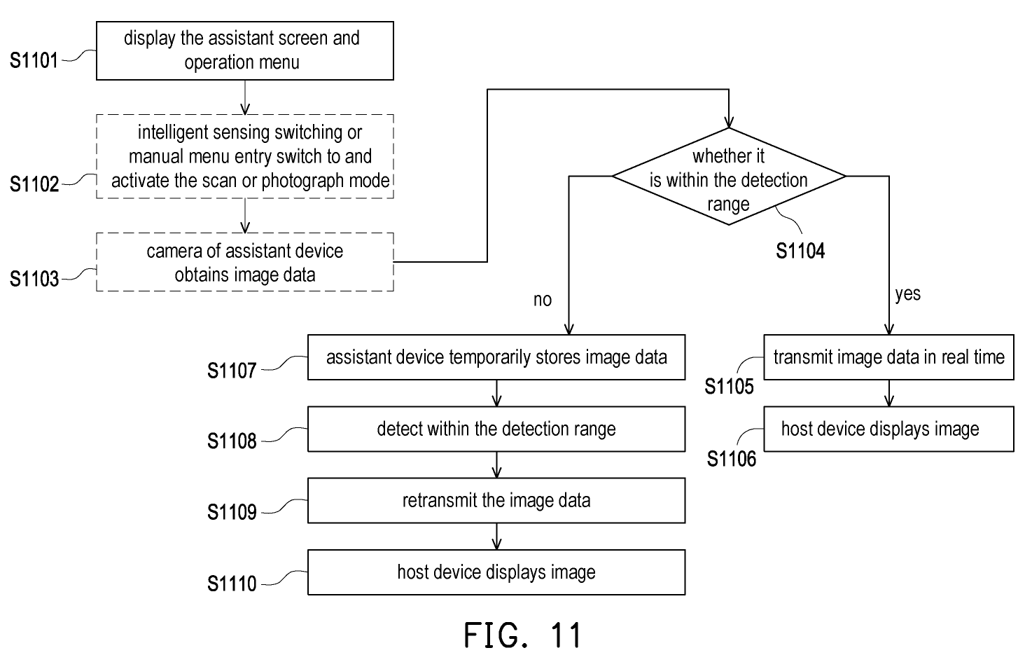

To more clearly illustrate the operational details of each individual interactive function, the following will elaborate in detail on the “scan/photograph function/mode” and “touch drawing function/mode”. FIG. 11 is an operational flowchart illustrating the scan or photograph mode in the detach state according to an embodiment of the disclosure.

Referring to FIG. 11, in step S1101, the display 320 displays the assistant screen and operation menu. When it is detected that the assistant device 30 is in the third state S3 (suspended state) (i.e., intelligent sensing switching) or the user manually selects the photograph function (i.e., manual menu entry), in step S1102, it switches to and activates the scan or photograph mode. In step S1103, the processor 390 turns on the camera 330 and displays a viewfinder preview window through the display 320. The processor 390 receives an image capture instruction. The image capture instruction may come from the user pressing a virtual shutter button or physical button on the display 320. In response to the image capture instruction, the camera 330 captures image data of a target object (such as a document or physical item) (i.e., captures an image).

In step S1104, the host device 10 judges whether the assistant device 30 is within the detection range. The judgment criteria for this step are the same as step S660 in the FIG. 6 or the logic in FIG. 9B/9C. The processor 390 (or processor 190) judges whether the assistant device 30 is within the trusted area of the host device 10 according to the position relationship information.

If within the detection range, in step S1105, the image data is transmitted in real time. Specifically, the processor 390 transmits the image data to the host device 10 through the wireless communication transceiver 310. In step S1106, the host device 10 may display the image data on the display 120 in real time, or directly import it into editing software.

On the other hand, if not within the detection range, in step S1107, the image data is temporarily stored. Specifically, to save bandwidth or protect privacy, the processor 390 stores the image data in the local memory of the assistant device 30 without performing wireless transmission. When it is subsequently detected that the assistant device 30 returns to the detection range (step S1108), the image data is retransmitted (step S1109). In step S1110, the host device 10 may display the image data on the display 120 in real time, or directly import it into editing software.

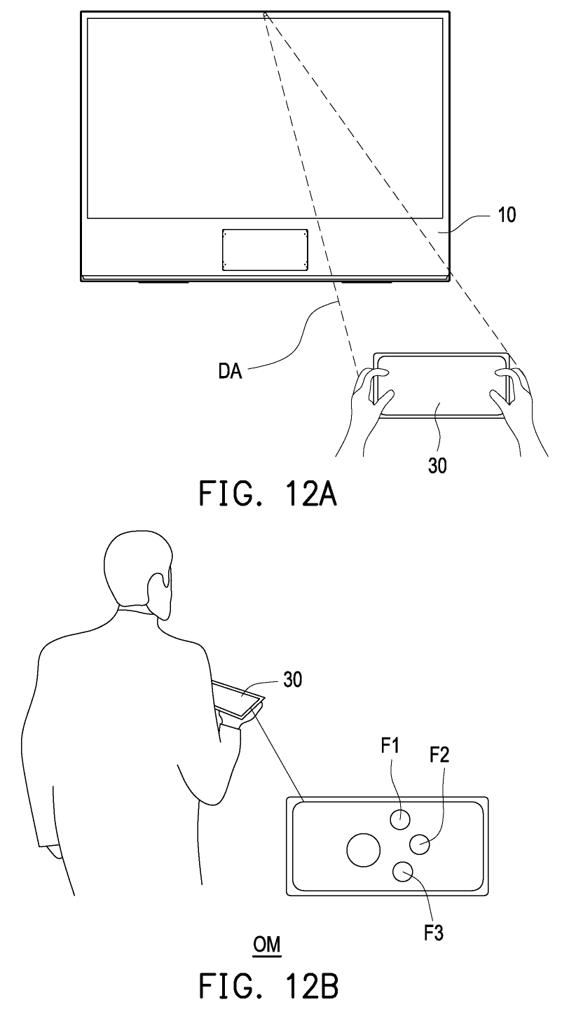

FIG. 12A is a schematic diagram illustrating a detach state according to an embodiment of the disclosure. Referring to FIG. 12A, this scenario corresponds to automatic detection/intelligent sensing switching mode. When the user picks up the assistant device 30 from the desktop and makes it in a suspended state (i.e., the third state S3), the sensor 350 detects acceleration change or non-stationary state. The processor 390 automatically judges that the user’s intention is to photograph, and then switches to scan or photograph mode (i.e., the target function is scan/photograph function), and displays a viewfinder preview window and shutter button on the display 320. At this time, the function option F1 (camera icon) in the operation menu OM as shown in FIG. 7 presents an activated state.

FIG. 12B is a schematic diagram illustrating manual switching mode according to an embodiment of the disclosure. Referring to FIG. 12B, this scenario illustrates that even when the judgment of the sensor 350 does not match the user’s intention (for example, the user places the assistant device 30 flat but still wants to use the camera 330), the user may still intervene through manual operation. The touch panel 335 detects the user’s click operation on the function option F1 in the operation menu OM. In response to this click operation, the processor 390 forcibly switches to scan or photograph mode, regardless of what the current posture information is.

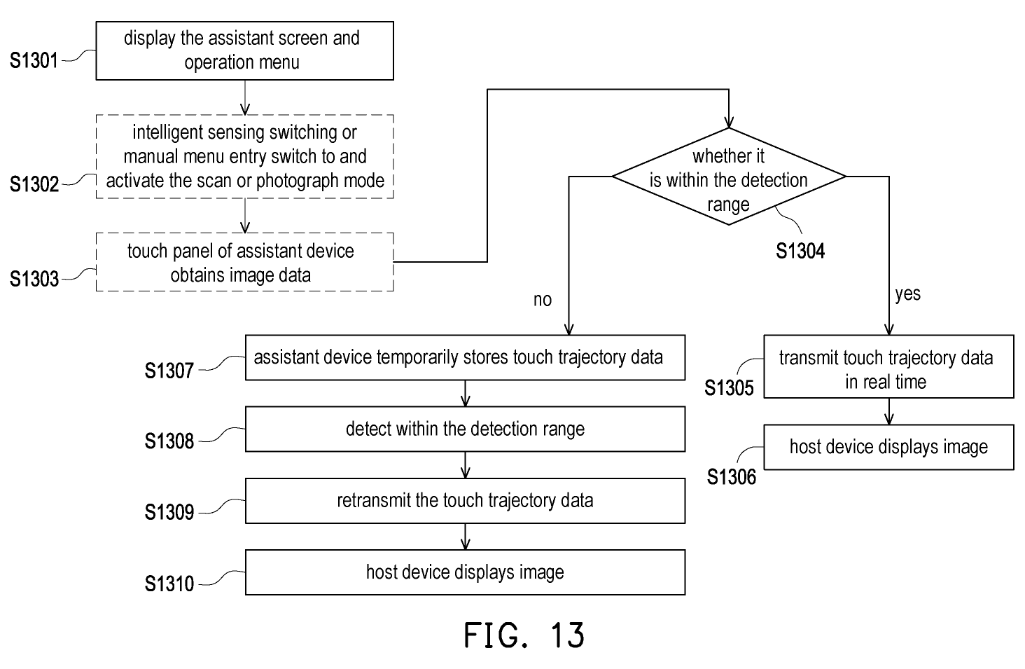

Next, the touch drawing mode is described. FIG. 13 is an operation flowchart illustrating the touch drawing mode according to an embodiment of the disclosure. Referring to FIG. 13, in step S1301, the display 320 displays the assistant screen and operation menu. When it is detected that the assistant device 30 is in the second state S2 (lying flat state) (i.e., intelligent sensing switching) or the user manually selects the touch input function (i.e., manual menu entry), in step S1302, it switches to and activates the touch drawing mode. In step S1303, the processor 390 displays a drawing interface or handwriting input board through the display 320, and receives touch input through the touch panel 335. The touch panel 335 detects the movement trajectory of the user’s finger or stylus, and generates touch trajectory data.

In step S1304, the host device 10 judges whether the assistant device 30 is within the detection range. The judgment criteria of this step are the same as step S660 of the FIG. 6 or the logic of FIG. 9B/9C. The processor 390 (or processor 190) judges whether the assistant device 30 is within the trusted area of the host device 10 according to the position relationship information.

If within the detection range, in step S1305, the touch trajectory data is transmitted in real time. Specifically, the assistant device 30 transmits the touch trajectory data to the host device 10 in real time. Then, the display 120 of the host device 10 synchronously displays the drawing image, that is, synchronously displays the drawing process corresponding to the touch trajectory data, and realizes the collaborative experience of “small screen drawing, large screen display”.

On the other hand, if not within the detection range, in step S1307, the touch trajectory data is temporarily stored. Specifically, in order to save bandwidth or protect privacy, the processor 390 stores the touch trajectory data in the local memory of the assistant device 30, without performing wireless transmission. The assistant device 30 only displays the drawing result on the local display 320.

When it is subsequently detected that the assistant device 30 returns to within the detection range (step S1308), the touch trajectory data is retransmitted (step S1309). In step S1310, the host device 10 may display the image corresponding to the touch trajectory data on the display 120 in real time. This mode allows the user to use the assistant device 30 as an independent digital notebook, and then synchronize it to the host device 10 after returning to the seat.

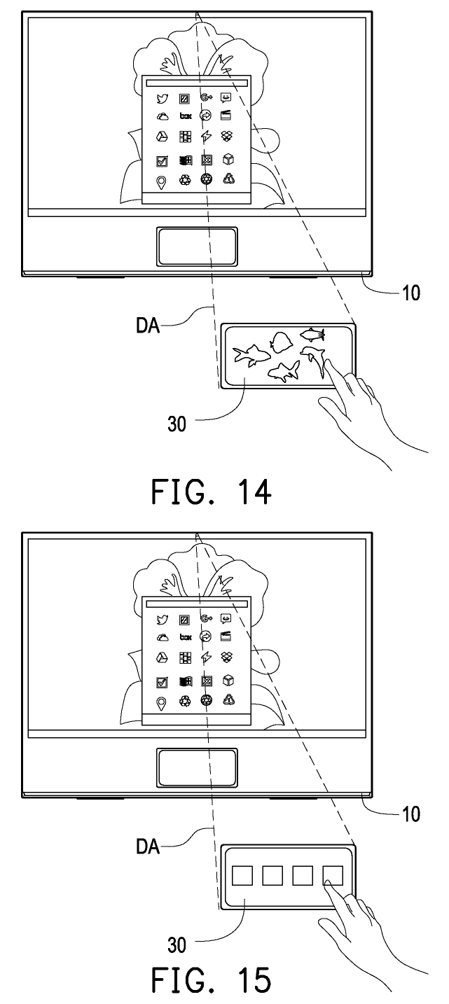

FIG. 14 is a schematic diagram illustrating an automatic detection mode according to an embodiment of the disclosure. Referring to FIG. 14, when the user places the assistant device 30 lying flat on the desktop (i.e., the second state S2), the sensor 350 detects that the tilt angle is less than the angle threshold (for example, 30 degrees). The processor 390 automatically switches to the touch drawing mode (i.e., the target function is the touch input function), and displays the drawing interface. At this time, the function option F2 (pen/touch icon) in the operation menu OM is in an activated state. On the other hand, the image captured by the camera 130 may be used to analyze the user’s gestures, and provide corresponding control accordingly.

FIG. 15 is a schematic diagram illustrating a manual switching mode according to an embodiment of the disclosure. Referring to FIG. 15, when the assistant device 30 is in an upright state (i.e., the second state S2), the sensor 350 detects changes in speed and distance, thereby causing the display to present the interface corresponding to the touch input function. At this time, regardless of whether the camera 130 of the host device 10 senses an authorized user or the assistant device 30 within the detection range DA, the display 320 of the assistant device 30 only displays the assistant screen. In addition, the touch panel 335 detects whether there is user operation on the assistant screen. If user operation targeting the assistant screen is detected, the display 320 displays the operation menu OM. If the user wishes to perform drawing in a non-lying flat state (for example, when handheld), the user may click the function option F2 in the operation menu OM. The processor 390 responds to this user operation by forcibly switching to the touch drawing mode (i.e., the target function is the touch input function), for the user to perform handheld note-taking or annotation.

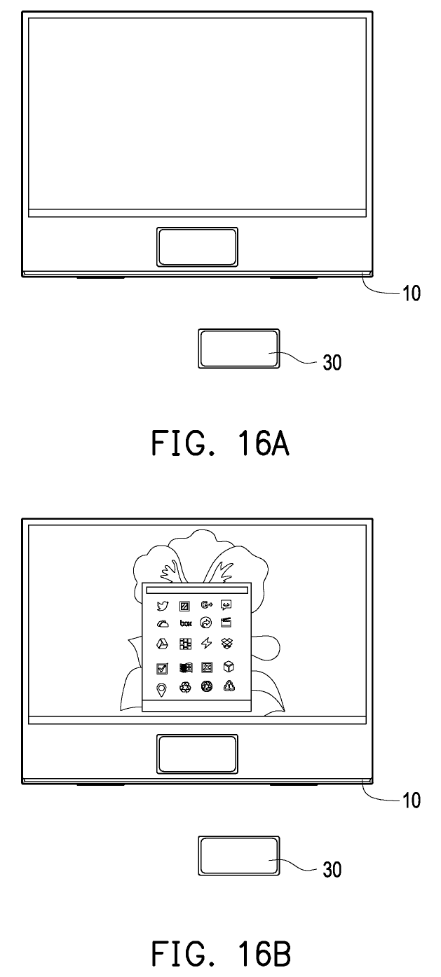

Finally, the processing mechanism of the detachable system 1 under abnormal state is described. FIG. 16A is a schematic diagram illustrating disconnection or no power according to an embodiment of the disclosure. Referring to FIG. 16A, this scenario corresponds to the host device 10 being shut down, powered off, or the assistant device 30 exceeding the signal connection range of the wireless communication transceiver 310.

When the processor 390 of the assistant device 30 detects through the wireless communication transceiver 310 that the connection with the host device 10 is interrupted (for example, handshake signals are not received consecutively multiple times or an offline notification is issued by the host device 10), the processor 390 judges that the system is in a disconnected state. At this time, the processor 390 controls the display 320 to display a disconnection prompt interface. The disconnection prompt interface may include warning icons (such as exclamation marks or disconnection symbols) and/or text messages, prompting the user “Host not connected” or “Signal lost”. In the disconnected state, the assistant device 30 may automatically switch to an independent operation mode, retaining only locally executable functions (for example, local album browsing or basic settings), and suspending target functions that require interaction with the host device 10 (for example, real-time video conferencing or remote desktop) and data transmission. After power is restored or network connection is reestablished, transmission may resume.

FIG. 16B is a schematic diagram illustrating the assistant device having no power according to an embodiment of the disclosure. Referring to FIG. 16B, this scenario corresponds to the assistant device 30 having excessively low power. The processor 390 continuously monitors the power state of the power module 385. When the power is below a power threshold value (for example, 15% or 5%), the processor 390 judges that the system is in a low power state. At this time, the processor 390 controls the display 320 to display a low power prompt interface. The low power prompt interface may include a charging indication icon (such as a battery symbol) and/or text messages, prompting the user “Please return to charging platform”. This prompt is intended to guide the user to attach the assistant device 30 back to the charging platform CP1 of the host device 10 (as shown in FIG. 3A), to perform charging and restore to the combined state AS. The assistant device 30 may perform charging in the combined state AS. During the charging process, data transmission with the host device 10 may be performed.

In summary, in the control method for the detachable system and the detachable system according to embodiments of the disclosure, by detecting state information (such as detach or combined state) or posture information (such as standing, lying flat, or suspended state) of the assistant device, the user’s operation intention is intelligently judged and automatically switched to corresponding target functions (such as voice input, touch input, or photograph function). Furthermore, embodiments of the disclosure may further dynamically adjust data transmission strategies according to position relationship information (such as whether within detection range and whether an authorized user), ensuring data transmission efficiency while effectively protecting user privacy. Moreover, by combining the dual mechanism of automatic sensing and manual menu, an extremely flexible and intuitive human-machine interaction experience is provided, solving the problems of limited operation and cluttered screen of traditional all-in-one machines.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A control method for a detachable system, wherein the detachable system comprises a host device and an assistant device, the host device and the assistant device being separable or detachable, the control method comprising:
detecting posture information of the assistant device;
detecting state information of the host device and the assistant device, wherein the state information is one of a combined state and a detach state; and
according to the state information or the posture information, activating a target function among a plurality of interactive functions between the host device and the assistant device.

2. The control method for a detachable system according to claim 1, further comprising:
when the state information is the combined state, disabling the target function, wherein the target function is configured to transmit user operation data received by an input device of the assistant device to the host device.

3. The control method for a detachable system according to claim 2, further comprising:
through an input device of the host device, receiving the user operation data.

4. The control method for a detachable system according to claim 1, further comprising:
detecting the state information of the host device and the assistant device, wherein the state information is one of the combined state and the detach state; and
when the state information is the detach state, activating the target function, wherein the target function is configured to transmit user operation data received by an input device of the assistant device to the host device.

5. The control method for a detachable system according to claim 4, wherein activating the target function among the interactive functions between the host device and the assistant device according to the state information or the posture information comprises:
when detecting that the posture information under the state information corresponds to a standing state, determining that the target function corresponds to a voice input function, wherein the user operation data comprises voice data.

6. The control method for a detachable system according to claim 4, wherein activating the target function among the interactive functions between the host device and the assistant device according to the state information or the posture information comprises:
when detecting that the posture information under the state information corresponds to a lying flat state, determining that the target function corresponds to at least one of a touch input function or a voice input function, wherein the user operation data comprises at least one of touch trajectory data or voice data.

7. The control method for a detachable system according to claim 4, wherein activating the target function among the interactive functions between the host device and the assistant device according to the state information or the posture information comprises:
when detecting that the posture information under the state information corresponds to a suspended state, determining that the target function corresponds to at least one of a voice input function, a touch input function, or a photograph function, wherein the user operation data comprises at least one of voice data, touch trajectory data, or image data.

8. The control method for a detachable system according to claim 4, further comprising:
disabling other interactive functions except the target function.

9. The control method for a detachable system according to claim 4, further comprising:
determining a data transmission method of the user operation data according to position relationship information between the host device and the assistant device.

10. The control method for a detachable system according to claim 9, wherein determining the data transmission method of the user operation data according to the position relationship information between the host device and the assistant device comprises:
determining whether the assistant device is located within a detection range, wherein the position relationship information corresponds to a position relationship between the assistant device and the detection range;
when the assistant device is located within the detection range, transmitting the user operation data to the host device; and
when the assistant device is not located within the detection range, restricting data types transmitted to the host device.

11. The control method for a detachable system according to claim 10, wherein determining whether the assistant device is located within the detection range comprises:
recognizing whether a user corresponding to the assistant device in a captured image is an authorized user;
when the user corresponding to the assistant device is the authorized user, determining that the assistant device is located within the detection range; and
when the user corresponding to the assistant device is not the authorized user, determining that the assistant device is not located within the detection range.

12. The control method for a detachable system according to claim 10, wherein determining whether the assistant device is located within the detection range comprises:
detecting the position relationship information through a wireless signal; and
determining that the assistant device is located within the detection range according to the position relationship information.

13. The control method for a detachable system according to claim 1, further comprising:
providing a connection platform, wherein the connection platform is disposed on the host device, the assistant device is adapted to be attached to the connection platform, and the assistant device is in the combined state by being retracted into the host device together with rotation of the connection platform; and
driving the connection platform to rotate in reverse and switch to an appearance position, enabling the assistant device to separate from the connection platform, and the host device exposing the connection platform.

14. A detachable system, comprising:
a host device; and
an assistant device, wherein the host device and the assistant device are separable or detachable,
the assistant device detects its posture information,
the assistant device detects state information with the host device, the state information being one of a combined state and a detach state, and
the assistant device activates a target function among a plurality of interactive functions between the host device and the assistant device according to the state information or the posture information.

15. The detachable system according to claim 14, wherein
when the state information is the combined state, the assistant device disables the target function, and the target function is configured to transmit user operation data received by an input device of the assistant device to the host device.

16. The detachable system according to claim 15, wherein
an input device of the host device receives the user operation data.

17. The detachable system according to claim 14, wherein
the assistant device detects state information with the host device, the state information being one of the combined state and the detach state,
when the state information is the detach state, the assistant device activates the target function, and the target function is configured to transmit user operation data received by an input device of the assistant device to the host device.

18. The detachable system according to claim 17, wherein
when detecting that the posture information under the state information corresponds to a standing state, the assistant device determines that the target function corresponds to a voice input function, and the user operation data comprises voice data.

19. The detachable system according to claim 17, wherein
when detecting that the posture information under the state information corresponds to a lying flat state, the assistant device determines that the target function corresponds to at least one of a touch input function or a voice input function, and the user operation data comprises at least one of touch trajectory data or voice data.

20. The detachable system according to claim 17, wherein
when detecting that the posture information under the state information corresponds to a suspended state, the assistant device determines that the target function corresponds to at least one of a voice input function, a touch input function, or a photograph function, and the user operation data comprises at least one of voice data, touch trajectory data, or image data.

21. The detachable system according to claim 17, wherein
the assistant device disables other interactive functions except the target function.

22. The detachable system according to claim 17, wherein
the assistant device determines a data transmission method of the user operation data according to position relationship information between the host device and the assistant device.

23. The detachable system according to claim 22, wherein
the host device determines whether the assistant device is located within a detection range, the position relationship information corresponds to a position relationship between the assistant device and the detection range;
when the assistant device is located within the detection range, the assistant device transmits the user operation data to the host device; and
when the assistant device is not located within the detection range, the assistant device restricts data types transmitted to the host device.

24. The detachable system according to claim 23, wherein
the host device recognizes whether a user corresponding to the assistant device is an authorized user in a captured image;
when the user corresponding to the assistant device is the authorized user, the host device determines that the assistant device is located within the detection range; and
when the user corresponding to the assistant device is not the authorized user, the host device determines that the assistant device is not located within the detection range.

25. The detachable system according to claim 23, wherein
the host device detects the position relationship information through a wireless signal, and
the host device determines that the assistant device is located within the detection range according to the position relationship information.

26. The detachable system according to claim 14, wherein the host device comprises a connection platform, the assistant device is adapted to attach to the connection platform, and the assistant device is in the combined state by being retracted into the host device together with rotation of the connection platform.

27. The detachable system according to claim 26, wherein the connection platform rotates in reverse and switches to an appearance position, enabling the assistant device to separate from the connection platform, and the host device exposes the connection platform.
